(19) United States
(12) Patent Application Publication
(10) Pub. No.: US 2011/0161529 A1
(43) Pub. Date: Jun. 30, 2011

(54) COMMUNICATION APPARATUS AND INTERFACING METHOD FOR INPUT/OUTPUT CONTROLLER INTERFACE

(75) Inventor: PO CHOU CHEN, HSINCHU COUNTY (TW)

(73) Assignee: RALINK TECHNOLOGY CORPORATION, HSINCHU COUNTY (TW)

(21) Appl. No.: 12/981,751

(22) Filed: Dec. 30, 2010

(30) Foreign Application Priority Data
Dec. 31, 2009 (TW) 098146225

(51) Int. Cl. G06F 3/00

(52) U.S. Cl. 710/5

(57) ABSTRACT

A communication apparatus is disclosed. The communication apparatus comprises a transmission module and an I/O controller interface. The transmission module is configured to transmit data. The I/O controller interface acts as a host controller interface between the transmission module and a host module of an alternate MAC/PHY (AMP) manager. The I/O controller interface directs the transmission module to transmit and receive data of the AMP manager according to I/O request packets forwarded by the host module.

### BACKGROUND OF THE INVENTION

1. Field of the Invention

The present invention relates to a communication apparatus and method, and more particularly, to a communication apparatus comprising an input/output (I/O) controller interface and the interfacing method thereof.

2. Description of the Related Art

Bluetooth communication technology is a short-range wireless transmission technology with open specification. Bluetooth communication technology exhibits advantages of low power and low costs, and is widely used in many personal area network (PAN) applications, such as the data communication between a mobile phone and the headset thereof, or the data communication between a video game console and the controller thereof. However, Bluetooth communication technology is limited by its transmission speed and thus cannot be applied to wideband data communication, such as the data communication between a personal computer and the printer thereof.

Another wireless communication technology, wireless local area network (WLAN) technology, also known as Wi-Fi, utilizes Ethernet architecture, and can support wideband and long distance data communication. Accordingly, WLAN technology can be applied to the data communication of a personal computer in a local area network.

To overcome the issue of the low transmission rate of the Bluetooth communication technology, the newly developed Bluetooth communication technology standard, Bluetooth 3.0 + HS, utilizes the alternate media access control (MAC)/physical layer (PHY) manager (AMP manager) technique, which aims to provide Bluetooth data communication via another communication technology with higher data rate, such as Wi-Fi. However, there remain unsolved problems regarding communication between and integration of these two communication technologies, and an interfacing mechanism between the two communication technologies has not yet developed.

Therefore, there is a need to provide a communication apparatus capable of connecting two different communication technologies and the interfacing method thereof, such that one of the communication technologies can perform data transmission through the MAC/PHY of the other communication technology.

### SUMMARY OF THE INVENTION

The communication apparatus according to one embodiment of the present invention comprises a transmission module and an I/O controller interface. The transmission module is configured to perform data transmission. The I/O controller interface acts as a host controller interface between the transmission module and a host module of an AMP manager. The I/O controller interface directs the transmission module to transmit and receive data of the AMP manager according to I/O request packets forwarded by the host module.

The interfacing method for a host module of an AMP manager according to one embodiment of the present invention is disclosed. The host module exchanges data with a transmission module through an I/O controller interface. The interfacing method comprises the steps of: forwarding an I/O request packet for reading events to the I/O controller interface; forwarding an 1/0 request packet for receiving data to the I/O controller interface; forwarding an I/O request packet for transmitting data or executing instructions to the I/O controller interface if there is a datum to be transmitted or an instruction to be executed; carrying out the follow-up procedure of an event and forwarding another I/O request packet for reading events to the I/O controller interface if a completion response of the I/O request packet for reading the event is received from the I/O controller interface; and carrying out the follow-up procedure of a datum forwarding another I/O request packet for receiving data to the I/O controller interface if a completion response of the I/O request packet for receiving the datum is received from the I/O controller interface.

The interfacing method for an I/O controller interface according to one embodiment of the present invention is disclosed. The I/O controller interface connects a host module of an AMP manager to a transmission module for data transmission. The interfacing method comprises the steps to of: responding with a pending signal to the host module if an I/O request packet for reading events is received from the host module; responding with a pending signal to the host module if an I/O request packet for receiving data is received from the host module; responding with a completion response of an I/O request packet for transmitting data to the host module if is the I/O request packet for transmitting data is received from the host module, and determining a completion of an event after the datum is actually transmitted; responding with a completion response of an I/O request packet for executing instructions to the host module if the I/O request packet for executing instructions is received from the host module, and determining a completion of an event after the instruction is actually executed; filling a datum belonging to the AMP manager into an I/O request packet for receiving data if the datum is received from the transmission module, and then responding with a completion response of the 110 request packet for receiving data to the host module; and filling an event into an I/O request packet for reading events if the execution of the event is finished, and then responding with a completion response of the I/O request packet for reading events to the host module.

The foregoing has outlined rather broadly the features and technical advantages of the present invention in order that the detailed description of the invention that follows may be better understood. Additional features and advantages of the invention will be described hereinafter, and form the subject of the claims of the invention. It should be appreciated by those skilled in the art that the conception and specific embodiment disclosed may be readily utilized as a basis for modifying or designing other structures or processes for carrying out the same purposes as those of the present invention. It should also be realized by those skilled in the art that such equivalent constructions do not depart from the spirit and scope of the invention as set forth in the appended claims.

### BRIEF DESCRIPTION OF THE DRAWINGS

The objectives and advantages of the present invention will become apparent upon reading the following description and upon referring to the accompanying drawings of which:

FIG. 1 shows a communication apparatus according to an embodiment of the present invention;

FIG. 2 shows the flowchart of an interfacing method for a host module is of an AMP manager according to an embodiment of the present invention;

FIG. 3 shows the flowchart of an interfacing method for a host module of an AMP manager according to another embodiment of the present invention;

FIG. 4 shows the flowchart of an interfacing method for an I/O controller interface according to an embodiment of the present invention; and

FIG. 5 shows an application of the communication apparatus and the interfacing methods according to an embodiment of the present invention.

### DETAILED DESCRIPTION OF THE INVENTION

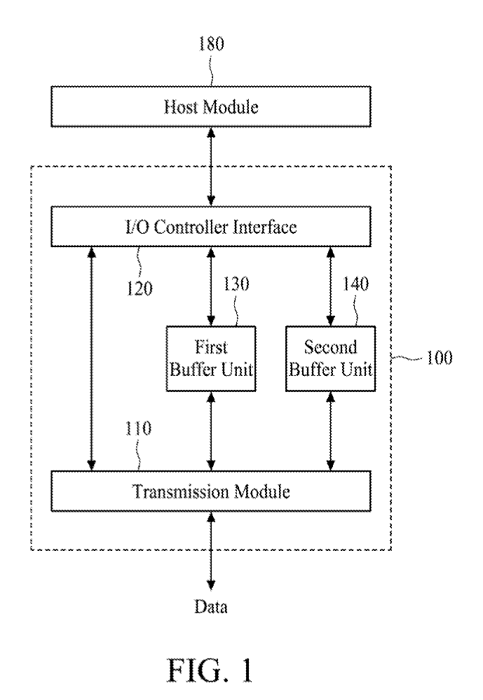

FIG. 1 shows a communication apparatus according to an embodiment of the present invention. As shown in FIG. 1, the communication apparatus 100 comprises a transmission module 110 and an I/O controller interface 120. The transmission module 110 is configured to perform data transmission. In some embodiments of the present invention, the transmission module 110 is a wireless local area network transmission module. The I/O controller interface 120 acts as a host controller interface (HCI) between the transmission module 110 and a host module 180 of an AMP manager. In some embodiments of the present invention, the AMP manager is configured to transmit Bluetooth communication signals via the transmission module 110. The I/O controller interface 120 directs the transmission module 110 to transmit and receive data of the AMP manager according to I/O request packets (IRP) forwarded by the host module 180. Preferably, the communication apparatus 100 further comprises a first buffer unit 130 and a second buffer unit 140. The first buffer unit 130 and the second buffer unit 140 are configured to store the I/O request packets from the host module 180. The following method exemplifies the operation of the communication apparatus 100.

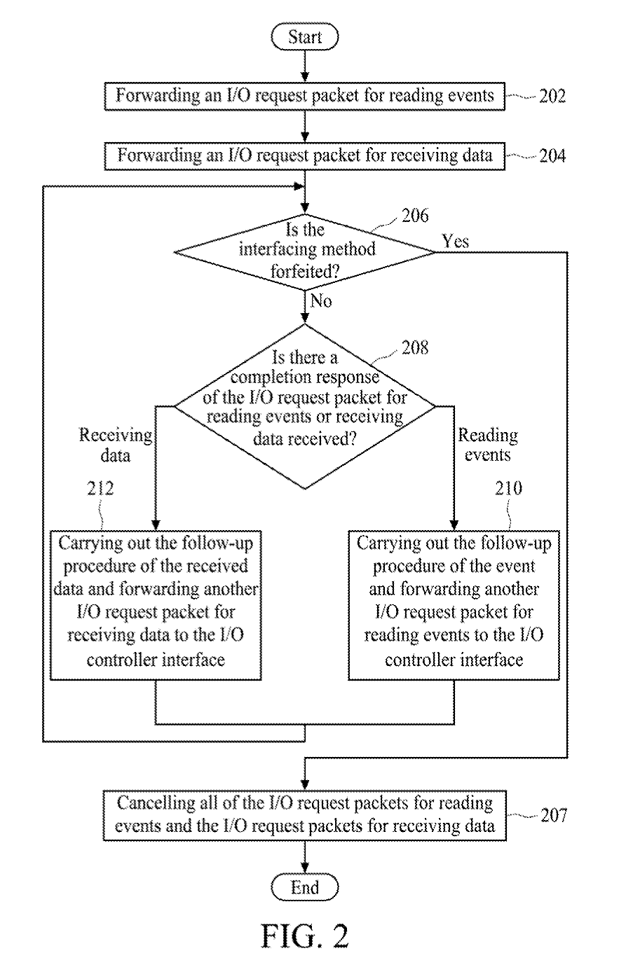

FIG. 2 shows the flowchart of an interfacing method for a host module of an AMP manager according to an embodiment of the present invention, wherein the host module exchanges data with a transmission module through an I/O controller interface. In some embodiments of the present invention, the transmission module is a wireless local area network transmission module, and the AMP manager is configured to transmit Bluetooth communication signals via the transmission module. In step 202, an I/O request packet for reading events is forwarded to the I/O controller interface, and step 204 is executed. In step 204, an I/O request packet for receiving data is forwarded to the I/O controller interface, and step 206 is executed. In step 206, it is determined whether to forfeit this interfacing method. If the interfacing method is forfeited, step 207 is executed; otherwise, step 208 is executed. In step 207, all of the I/O request packets for reading events and the I/O request packets for receiving data are canceled, and this interfacing method is concluded. In step 208, it is determined whether a completion response of the I/O request packet for reading events or a completion response of the I/O request packet for receiving data is received. If a completion response of the I/O request packet for reading events is received, step 210 is executed. If a completion response of the I/O request packet for receiving data is received, step 212 is executed. In step 210, the follow-up procedure of the event is carried out, another I/O request packet for reading events is forwarded to the I/O controller interface, and step 206 is executed. In step 212, the follow-up procedure of the received data is carried out, and another I/O request packet for receiving data is forwarded to the I/O controller interface, and step 206 is executed.

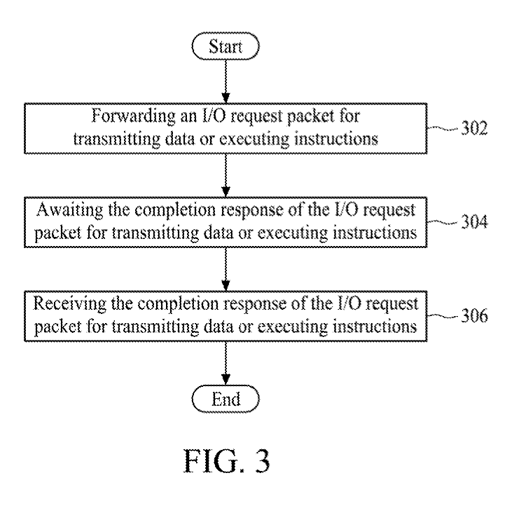

The method shown in FIG. 2 corresponds to the I/O request packets for reading events and receiving data. The following method corresponds to the I/O request packets for executing instructions and transmitting data. FIG. 3 shows the flowchart of an interfacing method for a host module of an AMP manager according to another embodiment of the present invention, wherein the host module exchanges data with a transmission module through an I/O controller interface. In step 302, an I/O request packet for transmitting data or executing instructions is forwarded to the I/O controller interface, and step 304 is executed. In step 304, the present interfacing method is halted to await the completion response of the I/O request packet for transmitting data or executing instructions, and step 306 is executed. In step 306, the completion response of the I/O request packet for transmitting data or executing instructions is received, and the present interfacing method is concluded.

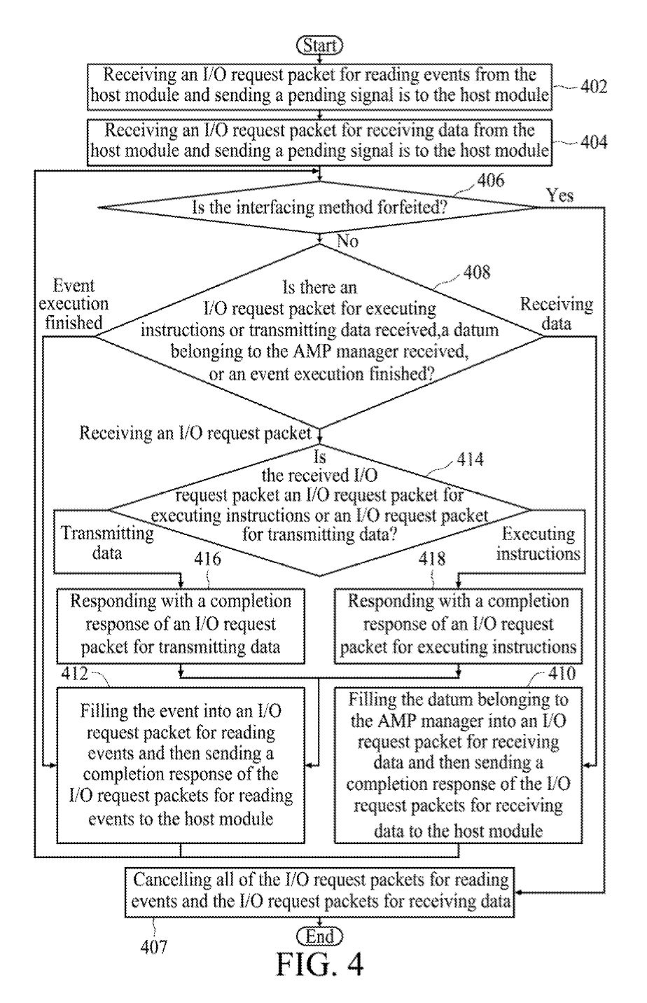

FIG. 4 shows the flowchart of an interfacing method for an I/O controller interface according to an embodiment of the present invention, wherein the I/O controller interface connects an AMP manager to a transmission module for data transmission. In some embodiments of the present invention, the transmission module is a wireless local area network transmission module, and the AMP manager is configured to transmit Bluetooth communication signals via the transmission module. In step 402, an I/O request packet for reading events is received from the host module, and a pending signal is responded to the host module, and step 404 is executed. In step 404, an I/O request packet for receiving data is received from the host module, and a pending signal is responded to the host module, and step 406 is executed. In step 406, it is determined whether to forfeit this interfacing method. If the interfacing method is forfeited, step 407 is executed; otherwise, step 408 is executed. In step 407, all of the I/O request packets for reading events and the I/O request packets for receiving data are canceled, and this interfacing method is finished. In step 408, it is determined whether an I/O request packet for executing instructions or an I/O request packet for transmitting data is received, whether a datum belonging to the AMP manager is received and whether an event execution is finished. If an I/O request packet for executing instructions or an I/O request packet for transmitting data is received, step 414 is executed. If a datum belonging to the AMP manager is received, step 410 is executed. If an event execution is finished, step 412 is executed. In step 410, the datum belonging to the AMP manager is filled into an I/O request packet for receiving data and then a completion response of the I/O request packets for receiving data is sent to the host module, and step 406 is executed. In step 412, the event is filled into an I/O request packet for reading events, and then a completion response of the I/O request packet for reading events is sent to the host module, and step 406 is executed. In step 414, it is determined whether the received I/O request packet is an I/O request packet for executing instructions or an I/O request packet for transmitting data. If the received I/O request packet is an I/O request packet for executing instructions, step 418 is executed. If the received I/O request packet is an I/O request packet for transmitting data, step 416 is executed. In step 416, a completion response of an I/O request packet for transmitting data is given, and step 412 is executed. In step 418, a completion response of an I/O request packet for executing instructions is given, and step 412 is executed.

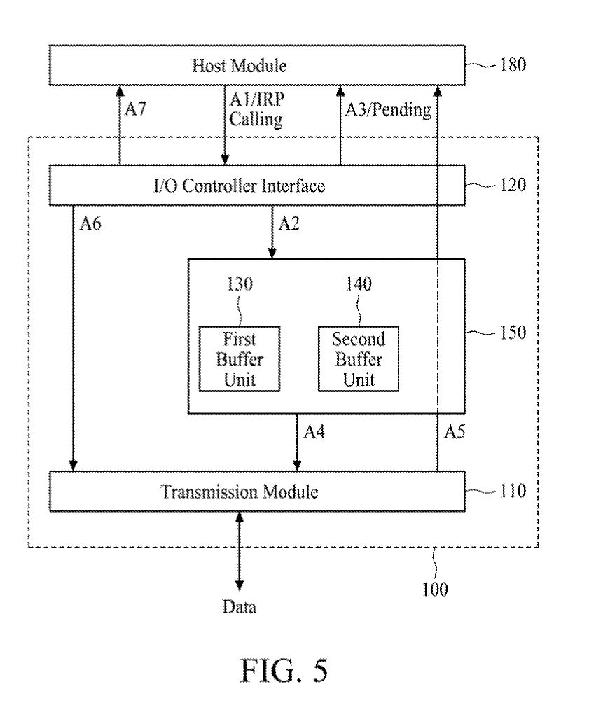

FIG. 5 shows application of the interfacing methods shown in FIGS. 2 to 4 to the communication apparatus shown in FIG. 1. Initially, in steps 202 and 204, the host module 180 forwards I/O request packets for reading events and receiving data to the I/O controller interface 120, as indicated by arrow A1. In response, in steps 402 and 404, the I/O controller interface 120 stores the I/O request packets for reading events into the first buffer unit 130, and stores the I/O request packets for receiving data into the second buffer unit 140, as indicated by arrow A2, wherein the first buffer unit 130 and the second buffer unit 140 constitute a buffer module 150. Subsequently, the I/O controller interface 120 responds with pending signals to the host module 180, as indicated by arrow A3. In some embodiments of the present invention, the first buffer unit 130 can store 32 I/O request packets for reading events, and the second buffer unit 140 can store 32 I/O request packets for receiving data. Accordingly, in steps 202 and 204, the host module 180 forwards 32 I/O request packets for reading events and 32 I/O request packets for receiving data to the I/O controller interface 120. Subsequently, the first buffer unit 130 and the second buffer unit 140 notify the transmission module 110 of the received I/O request packets for reading events and receiving data, as indicated by arrow A4.

In step 410, if the transmission module 110 receives a datum belonging to the AMP manager, the datum is filled into an I/O request packet for receiving data stored in the second buffer unit 140, and the I/O request packet for receiving data is then forwarded to the host module 180, as indicated by arrow A5. At this time, in step 212, the host module 180 carries out the follow-up procedure of the datum, and forwards another I/O request packet for receiving data to the I/O controller interface 120.

In step 412, if the execution of an event, such as a data transmission, the execution of an instruction, the check operation of a connection status, or the check operation for the transmission module 110, is complete by the transmission module 110, the event is filled into an I/O request packet for reading events stored in the second buffer unit 130, and the I/O request packet for reading events is then forwarded to the host module 180, as indicated by arrow A5. At this time, in step 210, the host module 180 carries out the follow-up procedure of the event, and forwards another I/O request packet for reading events to the I/O controller interface 120.

As described above, the host module 180 forwards another I/O request packet for receiving data or reading events to the I/O controller interface 120 after receiving a completion response of an I/O request packet for receiving data or reading events. Accordingly, there are always 32 pending I/O request packets for receiving data and 32 pending I/O request packets for reading events in the I/O controller interface 120.

In step 302, if the host module 180 requires a datum to be transmitted or an instruction to be executed, the host module 180 forwards an I/O request packet for transmitting data or an I/O request packet for executing instructions to the I/O controller interface 120, as indicated by arrow A1. In step 416, if the I/O controller interface 120 receives an I/O request packet for transmitting data, it then sends a completion response of the I/O request packet for transmitting data to the host module 180, as indicated by arrow is A7, and it then notifies the transmission module 110 to transmit the datum, as indicated by arrow A6. After the datum is transmitted, an execution of an event is deemed complete, the event is filled into an I/O request packet for reading events stored in the first buffer unit 130, and the I/O request packet for reading events is then forwarded to the host module 180, as indicated by arrow A5.

In step 418, as indicated by arrow A6, if the I/O controller interface 120 receives an I/O request packet for executing instructions, it then sends a completion response of the I/O request packet for executing instructions to the host module 180, as indicated by arrow A7, wherein the instruction can be an instruction for establishing physical connection, establishing logical connection, adjusting transmission rate or adjusting transmission power. After the instruction is executed by the transmission module 110, an execution of an event is deemed complete, the event is filled into an I/O request packet for reading events stored in the first buffer unit 130, and the I/O request packet for reading events is then forwarded to the host module 180, as indicated by arrow A5.

In conclusion, the present invention provides a communication apparatus and the interfacing method thereof, wherein the communication apparatus exhibits an interface to connect two different communication technologies, such that one of the communication technologies can perform data transmission through the MAC/PHY of the other communication technology. For example, the communication apparatus and the interfacing method thereof provided by the present invention can be applied to Bluetooth communication technology and Wi-Fi WLAN communication technology. Accordingly, a Bluetooth communication apparatus can perform data transmission through a Wi-Fi WLAN communication apparatus such that the transmission rate of the Bluetooth communication apparatus can be increased.

Although the present invention and its advantages have been described in detail, it should be understood that various changes, substitutions and alterations can be made herein without departing from the spirit and scope of the invention as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A communication apparatus, comprising:
a transmission module, configured to perform data transmission; and
an input/output (I/O) controller interface, acting as a host controller interface between the transmission module and a host module of an alternate media access control (MAC)/physical layer (PHY) manager (AMP manager);
wherein the I/O controller interface directs the transmission module to transmit and receive data of the AMP manager according to I/O request packets forwarded by the host module.

2. The communication apparatus of claim 1, wherein the I/O request packets comprise I/O request packets for reading events, I/O request packets for receiving data, I/O request packets for transmitting data and I/O request packets for executing instructions.

3. The communication apparatus of claim 2, wherein when the I/O controller interface receives an I/O request packet for reading events, the I/O controller interface is configured to respond with a pending signal to the host module and store the received I/O request packet for reading events into a first buffer unit.

4. The communication apparatus of claim 2, wherein when the I/O controller interface receives an I/O request packet for receiving data, the I/O controller interface is configured to respond with a pending signal to the host module and store the received I/O request packet for receiving data into a second buffer unit.

5. The communication apparatus of claim 2, wherein when the I/O controller interface receives an I/O request packet for transmitting data, the I/O controller interface is configured to send a completion response of the I/O request packet for transmitting data to the host module, and the I/O controller interface is configured to forward a completion response of an I/O request packet for reading events to the host module after the datum is transmitted.

6. The communication apparatus of claim 2, wherein when the I/O controller interface receives an I/O request packet for executing instructions, the I/O controller interface is configured to send a completion response of the I/O request packet for executing instructions to the host module, and the I/O controller interface is configured to forward a completion response of an I/O request packet for reading events to the host module after the instruction is executed.

7. The communication apparatus of claim 1, wherein the AMP manager is configured to transmit Bluetooth communication signals via the transmission module.

8. The communication apparatus of claim 1, wherein the transmission module is a wireless local area network transmission module.

9. An interfacing method for a host module of an alternate media access control (MAC)/physical layer (PHY) manager (AMP manager), the host module exchanging data with a transmission module through an input/output (I/O) controller interface, the method comprising the steps of:
forwarding an I/O request packet for reading events to the I/O controller interface;
forwarding an 1/0 request packet for receiving data to the I/O controller interface;
forwarding an I/O request packet for transmitting data or executing instructions to the I/O controller interface if there is a datum to be transmitted or an instruction to be executed;
carrying out the follow-up procedure of an event and forwarding another I/O request packet for reading events to the I/O controller interface if a completion response of the 1/0 request packet for reading the event is received from the I/O controller interface; and
carrying out the follow-up procedure of a datum forwarding another I/O request packet for receiving data to the I/O controller interface if a completion response of the I/O request packet for receiving the datum is received from the I/O controller interface.

10. The interfacing method of claim 9, further comprising the step of:
cancelling all of the I/O request packets for reading events and receiving data if the interfacing method is to be forfeited.

11. The interfacing method of claim 9, wherein the forwarded I/O request packet for reading events is stored in the I/O controller interface before the operation of reading events is completed.

12. The interfacing method of claim 9, wherein the forwarded I/O request packet for receiving data is stored in the I/O controller interface before operation of receiving data is completed.

13. An interfacing method for an input/output (I/O) controller interface, the I/O controller interface connecting a host module of an alternate media access control (MAC)/physical layer (PHY) manager (AMP manager) to a transmission module for data transmission, the method comprising the steps of:
responding with a pending signal to the host module if an I/O request packet for reading events is received from the host module;
responding with a pending signal to the host module if an I/O request packet for receiving data is received from the host module;
responding with a completion response of an I/O request packet for transmitting data to the host module if the I/O request packet for transmitting data is received from the host module, and determining a completion of an event after the datum is actually transmitted;
responding with a completion response of an I/O request packet for executing instructions to the host module if the I/O request packet for executing instructions is received from the host module, and determining a completion of an event after the instruction is actually executed;
filling a datum belonging to the AMP manager into an I/O request packet for receiving data if the datum is received from the transmission module, and then responding with a completion response of the I/O request packet for receiving data to the host module; and
filling an event into an I/O request packet for reading events if the execution of the event is finished, and then responding with a completion response of the I/O request packet for reading events to the host module.

14. The interfacing method of claim 13, further comprising the step of:
cancelling all of the I/O request packets for reading events and receiving data if the interfacing method is to be forfeited.

15. The interfacing method of claim 13, wherein the I/O request packet for reading events is stored in a first buffer.

16. The interfacing method of claim 13, wherein the I/O request packet for receiving data is stored in a second buffer.

17. The interfacing method of claim 13, wherein the instructions comprise establishing physical connection, establishing logical connection, adjusting transmission rate and adjusting transmission power.

18. The interfacing method of claim 13, wherein the executed events comprise checking connection status and checking the status of the transmission module.
